(19) United States
(12) Patent Application Publication
(10) Pub. No.: US 2008/0205260 A1
(43) Pub. Date: Aug. 28, 2008

(54) SYSTEM AND METHOD FOR TRANSMITTING DATA BURSTS IN COMMUNICATION SYSTEMS

(75) Inventors: Mi-Hyun Lee, Seoul (KR); Jung-Soo Woo, Suwon-si (KR); Su-Ryong Jeong, Suwon-si (KR); Ki-Chun Cho, Suwon-si (KR); Dong-Seek Park, Yongin-si (KR); Jae-Weon Cho, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/038,366

(22) Filed: Feb. 27, 2008

(30) Foreign Application Priority Data
Feb. 27, 2007 (KR) 19760/2007

(51) Int. Cl. H04J 11/00

(52) U.S. Cl. 370/208

(57) ABSTRACT

Disclosed is a method for transmitting data bursts by a base station in a communication system, including forming one group which includes at least one subchannel and transmitting at least two data bursts having an equal transmission characteristic through each subchannel included in the group.

### PRIORITY

This application claims priority to application filed with the Korean Intellectual Property Office on Feb. 27, 2007, and assigned Serial No. 2007-19760, the contents of which are incorporated herein by reference.

### BACKGROUND OF THE INVENTION

1. Field of the Invention

The present invention relates to a communication system, and more particularly to a system and method for transmitting a data burst.

2. Description of the Related Art

An Orthogonal Frequency Division Multiplexing (OFDM) scheme is suitable for high-speed data transmission through wired/wireless channels. In addition, the OFDM scheme uses a subchannel including a plurality of subcarriers, thereby easily achieving multiple access.

Meanwhile, an Orthogonal Frequency Division Multiple Access (OFDMA) scheme achieves multiple access by providing a part of the subcarriers to a plurality of users by one to one.

In OFDM/OFDMA-based communication systems, subchannel allocation schemes may be classified into a localized allocation scheme and a distributed allocation scheme.

The localized allocation scheme is a scheme of forming one subchannel with a plurality of adjacent subcarriers, and can be applied to multi-antenna technology, such as beamforming, preceding, Spatial Division Multiple Access (SDMA), etc., by providing interference estimation and nulling.

The distributed allocation scheme forms one subchannel with a plurality of subcarriers which are widely distributed over the entire frequency band, and minimizes interference between adjacent cells.

Meanwhile, in the OFDM/OFDMA-based communication systems, a minimum unit for resource allocation may be defined as a two-dimensional block including time and frequency units. In this case, the two-dimensional block groups a plurality of consecutive subcarriers and a plurality of consecutive symbols.

FIGS. 1A and 1B illustrate the conventional method of forming a subchannel by using a two-dimensional block as a resource allocation unit. FIGS. 1A and 1B show one subchannel created by one or more blocks. FIG. 1A illustrates the structure of a subchannel of a plurality of blocks, and FIG. 1B illustrates the structure of a subchannel of only one block.

FIG. 2 illustrates a frame structure according to the conventional subchannel configuration scheme with one block including resources of 9 frequency units by 8 time units to make up one subchannel, with each subchannel used to transmit one data burst.

Generally, the size of a data burst is determined by a Modulation and Coding Scheme (MCS) level according to service characteristics and user environments. For example, in order to transmit a data burst larger than a predetermined size, a plurality of subchannels must be used. In this case, even if the number of blocks making up one subchannel is less than a reference number of blocks, it is possible to obtain a frequency diversity gain because a data burst is transmitted through the plurality of subchannels.

However, when the size of a data burst is smaller than the predetermined size, such as in Voice over IP (VoIP) service, the data burst is transmitted through subchannels fewer than a predetermined number of subchannels. In this case, it is impossible to obtain a sufficient frequency diversity gain.

### SUMMARY OF THE INVENTION

Accordingly, the present invention solves the above-mentioned problems of conventional systems, and the present invention provides a method for enhancing a frequency diversity gain upon data burst transmission by efficiently forming a subchannel in a communication system.

In accordance with an aspect of the present invention, there is provided a method for transmitting data bursts by a base station in a communication system, the method including forming one group which includes at least one subchannel and transmitting at least two data bursts having an equal transmission characteristic through each subchannel included in the group.

In accordance with another aspect of the present invention, there is provided a communication system that includes a base station for forming one group which includes at least one subchannel, and transmitting at least two data bursts having an equal transmission characteristic through each subchannel included in the group; and a mobile station for receiving the data bursts from the base station.

### BRIEF DESCRIPTION OF THE DRAWINGS

The above and other aspects, features and advantages of the present invention will be more apparent from the following detailed description taken in conjunction with the accompanying drawings, in which:

FIGS. 1A and 1B illustrate the conventional method of forming a subchannel by using a two-dimensional block as a resource allocation unit;

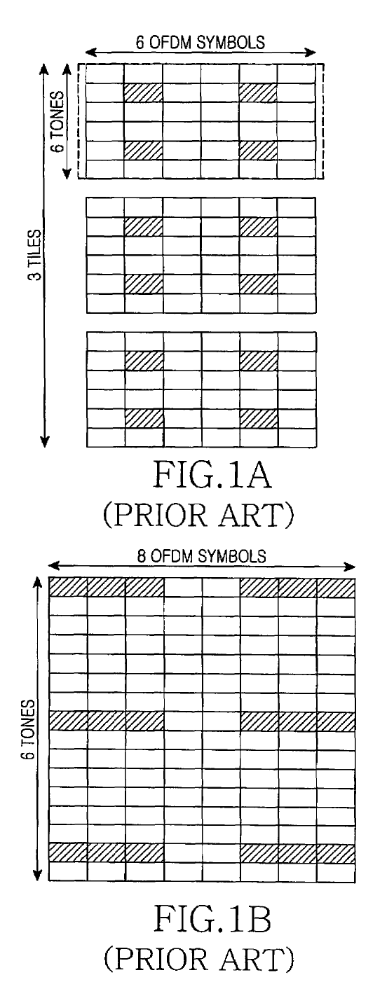

FIG. 2 illustrates a frame structure according to the conventional subchannel configuration scheme;

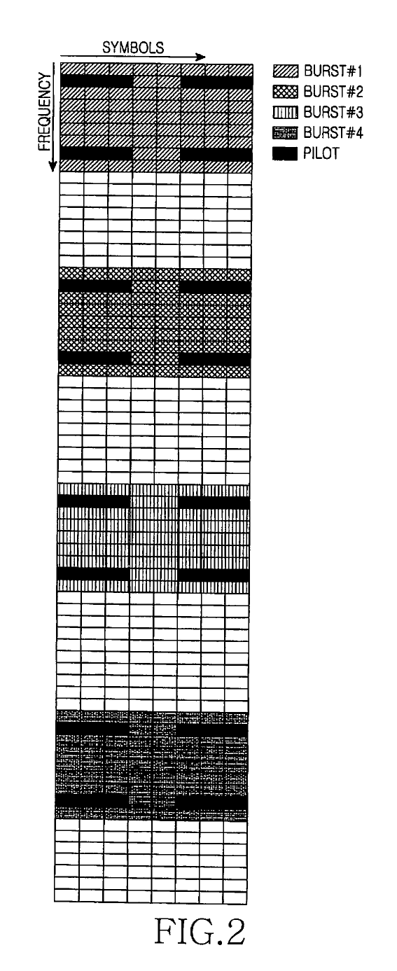

FIG. 3 illustrates the structure of a frame which includes subchannels classified by transmission characteristics according to an exemplary embodiment of the present invention;

FIG. 4 illustrates the structure of a frame constituted by subchannels according to an exemplary embodiment of the present invention;

FIG. 5 illustrates the structure of a frame constituted by subchannels according to an exemplary embodiment of the present invention; and

FIG. 6 is a flowchart illustrating a procedure of configuring a subchannel according to an exemplary embodiment of the present invention.

### DETAILED DESCRIPTION OF THE PREFERRED EMBODIMENTS

Hereinafter, exemplary embodiments of the present invention will be described with reference to the accompanying drawings. The following description will be given only about a part necessary to understand the operation of the present invention, and the other background technology will be omitted in order to prevent the subject matter of the present invention from being obscured.

The present invention provides a data burst transmission system and method for obtaining frequency diversity in a communication system which uses a plurality of subcarriers.

As described below, in the present invention allocated subchannels are grouped according to data burst transmission characteristics, and subcarriers within grouped subchannels hop a time axis. The subchannel is consists of one or more blocks. The block includes time and frequency resources. Such a subchannel may include a pilot pattern for use with multiple antennas. The data burst transmission characteristics are determined according to the fact that any one among a broadcast transmission scheme, a beamforming scheme, a Multi-Input Multi-Output (MIMO) scheme, a preceding scheme, etc. is applied to the data burst.

For example, the data burst may be transmitted to users who are mutually different, and may be transmitted in all directions via a single antenna. Here, the single antenna does not mean one physical antenna, but means one antenna group which can be classified into one group according to transmission characteristics. Therefore, an actual physical antenna may be a multi-antenna. For example, a base station or a mobile station includes a plurality of antennas, and each antenna is used to transmit each data burst divided according to transmission characteristics. That is, a first antenna may be used for a data burst transmitted in the form of broadcasting, while a second antenna is used for a data burst transmitted in the form of beamforming.

Meanwhile, the present invention can be applied to all communication systems, and, particularly, is preferably applied to a communication system using subcarriers. The communication system using subcarriers includes a broadband wireless access communication system, and the IEEE 802.16 communication system is a type of broadband wireless access communication system. That is, according to the present invention, it is possible to transmit data bursts having various transmission characteristics through the use of mutually different frequency bands during the same time period in the broadband wireless access communication system.

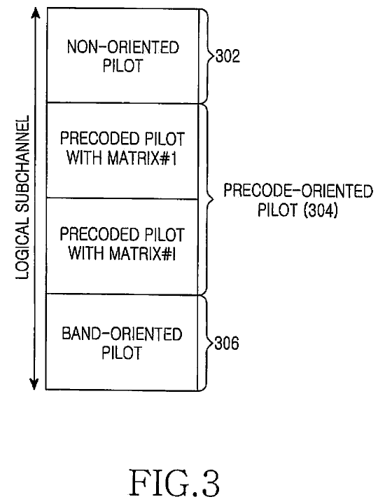

FIG. 3 illustrates the structure of a frame which includes subchannels classified by transmission characteristics according to an exemplary embodiment of the present invention.

Referring to FIG. 3, the frame includes a first subchannel 302 containing a non-oriented pilot transmitted in all directions, a second subchannel 304 containing a precode-oriented pilot transmitted in a specific direction, and a third subchannel 306 containing a band-oriented pilot transmitted depending on the characteristics of an allocated frequency band. In this case, the first subchannel 302 containing the non-oriented pilot is transmitted in all directions in the form of broadcasting, and the precode-oriented pilot of the second subchannel 304 is transmitted in a specific direction according to the characteristics of a reception space. In addition, the band-oriented pilot of the third subchannel 306 is transmitted through a specific frequency band according to reception frequency band characteristics. Therefore, the third subchannel containing the band-oriented pilot is allocated a frequency band, making it possible to obtain optimal performance according to the channel characteristics of the user, so that it is unnecessary to take a frequency diversity gain into consideration. However, on account of the configuration of subchannels based on a block structure, it is difficult for small-size data bursts transmitted through the non-oriented subchannel and the precode-oriented subchannel to obtain a sufficient frequency diversity gain.

For this reason, according to the present invention, subchannel transmission spaces occupied by small-size data bursts transmitted through either the non-oriented subchannel or the precode-oriented subchannel are grouped based on the same orientation. Then, the data bursts within each group are subjected to frequency hopping at a predetermined interval, to obtain a frequency diversity gain. Here, the interval may be a time interval, a frequency band interval, or an interval in which both time and frequency are reflected. The following description is given about a method for allocating data bursts having the same transmission characteristic to one or more subchannels included in one group.

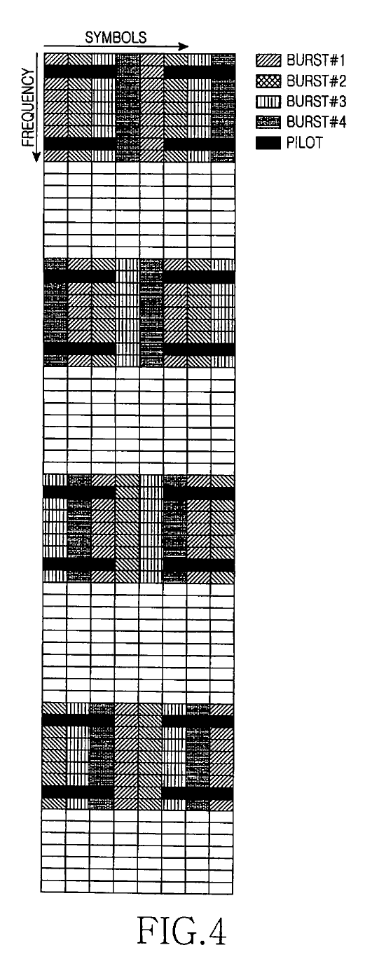

FIG. 4 illustrates the structure of a frame constituted by subchannels according to an exemplary embodiment of the present invention, in which one block has a size of 9 frequency units by 8 time units, one subchannel is constituted by one block, and one data burst is transmitted through four subchannels. For example, the number of data bursts transmitted through a first subchannel is four, and each data burst occupies two symbols, which are spaced from each other.

A frame structure newly proposed by the present invention shows, as an example, four subchannels grouped during an eight-OFDMA-symbol period, with the number of grouped subchannels being less than the number of symbols constituting one subchannel. Four subchannels are grouped by the same transmission characteristic, subcarriers within each subchannel in a four-subchannel region, which is a group region, hop a symbol period, i.e. to a time axis. For example, data burst #1 is located in first and fifth symbols of a first subchannel, and second and sixth symbols of a second subchannel. Otherwise, data burst #1 may be located in first and fifth symbols of the first subchannel, and first and fifth symbols of the second subchannel, as in the first subchannel. That is, a data burst may be distributed in such a manner as to have the same symbol indexes in mutually different subchannels.

Accordingly, one data burst is transmitted through four subchannels, so that it is possible to obtain an enhanced frequency diversity gain, as compared with the conventional method of transmitting one data burst through one subchannel.

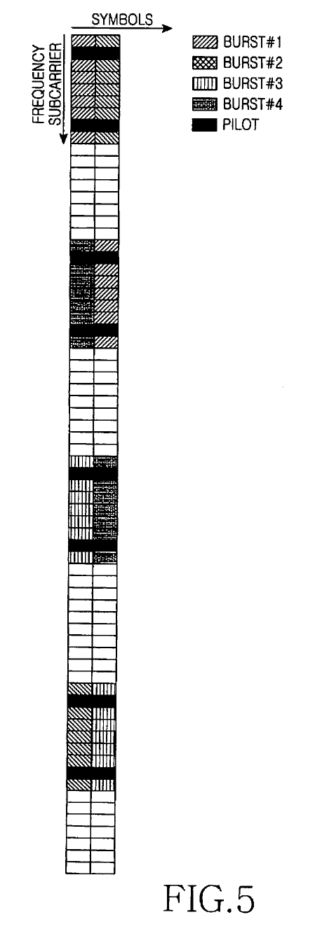

FIG. 5 illustrates the structure of a frame constituted by subchannels according to an exemplary embodiment of the present invention, in which one block has a size of 9 frequency units by 2 time units, one subchannel is constituted by one block, and one data burst is transmitted through two subchannels. For example, the number of data bursts transmitted through a first subchannel is two, and each data burst occupies one symbol in one subchannel.

A frame structure newly proposed by the present invention shows, as an example, four subchannels grouped during a two-OFDMA-symbol period, and the number of grouped subchannels is larger than the number of symbols constituting one subchannel. Four subchannels are grouped by the same transmission characteristic, subcarriers within each subchannel in a four-subchannel region, which is a group region, hop a symbol period, i.e. to a time axis. Accordingly, one data burst is transmitted through two subchannels, so that it is possible to obtain an enhanced frequency diversity gain, as compared with the conventional method of transmitting one data burst through one subchannel.

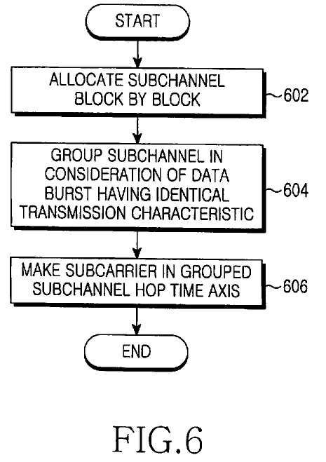

FIG. 6 is a flowchart illustrating a procedure of configuring a subchannel according to an exemplary embodiment of the present invention. First, subchannels are allocated block by block in step 602. Then, in step 604, the subchannels are grouped according to data bursts having the same transmission characteristic. In step 606, subcarriers within the subchannel regions included in one group hop the time axis.

As described above, according to the communication system of the present invention, when subchannels are allocated block by block, the subchannels are grouped in consideration of data bursts having the same transmission characteristic, and subcarriers in grouped subchannels hop the time axis, so that it is possible to obtain a frequency diversity.

While the present invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for transmitting data bursts by a base station in a communication system, the method comprising the steps of:
forming one group which includes at least one subchannel; and
transmitting at least two data bursts having a substantially same transmission characteristic through each subchannel included in the group.

2. The method as claimed in claim 1, wherein the transmission characteristic comprises at least one of a beamforming scheme, a Multi-Input Multi-Output scheme and a preceding scheme.

3. The method as claimed in claim 1, wherein the data bursts are transmitted to a plurality of mobile stations through multiple transmission antennas.

4. The method as claimed in claim 1, wherein each subchannel includes at least one pilot subcarrier.

5. The method as claimed in claim 1, wherein the data bursts are temporally distinguished from each other within each subchannel.

6. The method as claimed in claim 1, wherein the subchannel is constituted in units of blocks, each of which comprises a predetermined number of frequency resources and a predetermined number of time resources.

7. The method as claimed in claim 1, wherein a data burst of the at least two data bursts is transmitted through mutually different symbols in mutually different subchannels.

8. The method as claimed in claim 1, wherein a data burst of the at least two data bursts is transmitted through equal symbols in mutually different subchannels.

9. A communication system comprising:
a base station for forming one group which includes at least one subchannel, and transmitting at least two data bursts having a substantially same transmission characteristic through each subchannel included in the group; and
a mobile station for receiving the data bursts from the base station.

10. The system as claimed in claim 9, wherein the transmission characteristic comprises at least one of a beam forming scheme, a Multi-Input Multi-Output scheme and a precoding scheme.

11. The system as claimed in claim 9, wherein the base station transmits the data bursts through multiple transmission antennas.

12. The system as claimed in claim 9, wherein each subchannel includes at least one pilot subcarrier.

13. The system as claimed in claim 9, wherein the data bursts are temporally distinguished from each other within each subchannel.

14. The system as claimed in claim 9, wherein the subchannel is constituted in units of blocks each of which comprises a predetermined number of frequency resources and a predetermined number of time resources.

15. The system as claimed in claim 9, wherein a data burst of the at least two data bursts is transmitted through mutually different symbols in mutually different subchannels.

16. The system as claimed in claim 9, wherein a data burst of the at least two data bursts is transmitted through equal symbols in mutually different subchannels.
